(19) United States
(12) Patent Application Publication
(10) Pub. No.: US 2017/0342712 A1
(43) Pub. Date: Nov. 30, 2017

(54) CONSTRUCTION BLOCK SYSTEM

(71) Applicant: Mike Ellis, Sumner, MS (US)

(72) Inventor: Mike Ellis, Sumner, MS (US)

(21) Appl. No.: 15/162,734

(22) Filed: May 24, 2016

(51) Int. Cl. E04C 1/00; B32B 7/08; B32B 3/06; B32B 25/04

(52) U.S. Cl. CPC E04C 1/00; B32B 25/042; B32B 7/08; B32B 3/06; B32B 2250/248; B32B 2419/02

(57) ABSTRACT

A hard synthetic rubber construction block system that includes: a top block; a plurality of square-shaped cavities on the under side of the top block; a bottom block; a plurality of square shaped studs on the upper side of the bottom block that insert into the plurality of square cavities in the top block, binding them together. Other features of the construction block system include: a horizontal insert on each side of the upper portion of the lower block spanning its length; a matching V-groove inside the lower portion of the upper block whereby the described insert of the lower block snaps into it, creating a locking point. Further, tongue and groove connections are at each end of the blocks whereby the tongue feature on one end of a block slides into the groove feature of an adjoining block, locking them horizontally.

### BACKGROUND OF THE INVENTION

### Field of Invention

The present invention relates to a unique construction block used to build various structures.

### Description of Related Art

Throughout history construction blocks have been used in many forms to build various type structures. Traditional construction blocks may be made of concrete or brick, with cement used as a binder. These products are well known and have had successful application for many years. Although traditional construction blocks provide a sturdy and durable means to create a structure, they can be easily damaged or totally destroyed during natural disaster events. When natural disasters strike, it is very time consuming and costly to rebuild a structure. Therefore, it would be particularly advantageous to have a construction block made of highly resilient and flexible material, that could be quickly and easily assembled by the average person.

### SUMMARY OF THE INVENTION

The present invention relates to a hard but flexible rubber-like construction block system that includes: a 12″ wide×19″ tall×24″ long block, with four square shaped cavities on the underside, and four square shaped cavities on the upper side. When stacked, the square studs on the lower block insert into the square cavities of the upper block. This braces and binds the block together, giving the system strength and rigidity. Other features include a raised horizontal insert spanning the length of the block on each side. Located on the upper outside area of each block, this insert snaps into a receiving “V” groove located on the inside area of the adjoining upper block. Thirdly, on each end of the blocks are tongue and groove connections. One end of each block has a vertical tongue configuration on each side. The opposite end of each block has a corresponding vertical groove on each side. When placed end to end, the tongue feature of one block slides into the receiving groove of the adjoining block, locking them together. When blocks are stacked in alternate fashion, they are locked on top, bottom and both ends. This “snap-lock” system tightly binds the blocks on all four sides, creating a wall that is virtually inseparable without the use of nails, screws, or glue.

### BRIEF DESCRIPTION OF DRAWINGS

FIG. 1 depicts a construction block system in accordance with the present invention.

FIG. 2 depicts a side perspective view of the construction block system according to the present invention.

### DETAILED DESCRIPTION

The present invention relates to a building construction block system that utilizes a self-supporting and self-locking concept. The blocks are made of a hard, synthetic rubber material and include engaging openings adjoining with studs and inserts to lock the block system into place vertically. A tongue and groove connection is used to lock them into place horizontally. When attached and stacked in alternate fashion, the blocks create a very strong wall structure that is extremely tough, flexible and long lasting. Because of their flexible nature and resilience, these construction blocks are far more likely to withstand violent forces of nature than conventional building materials. Further, the blocks do not require nails, screws, cement or glue, and can be quickly and easily assembled by a nonprofessional builder.

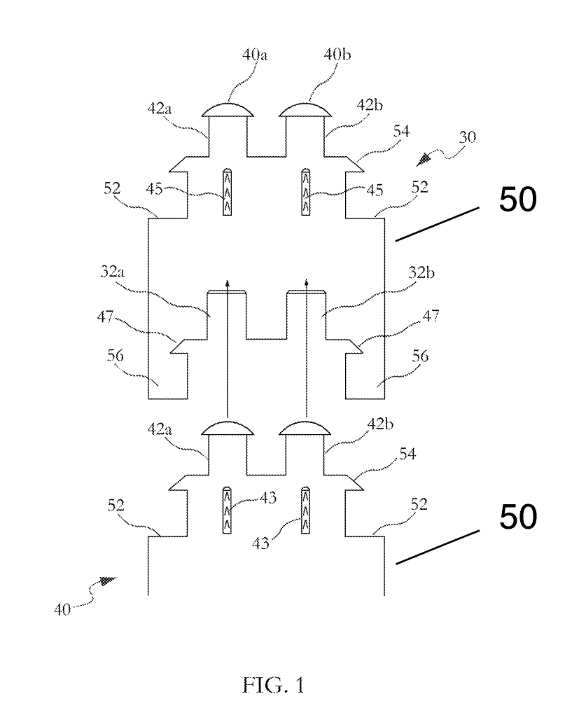

An exemplary block in accordance with the present invention is depicted in FIG. 1. This particular block system is assembled by the attachment of Top Block 30 to Bottom Block 40. Top Block 30 includes four Cavities 32a, 32b, 32c, and 32d on the under side that receive Studs 42a, 42b, 42c, and 42d extending from the upper side of lower block 40. Top Block 30 joins with Lower Block 40 to create a composite block for use with the Present invention.

As shown, Top Block 30 fits on top of Bottom Block 40 by entering the studs on Block 40 into the Cavities of Block 30, locking them into place. On each side of Bottom Block 40, is a horizontal insert 54, spanning the length of the block. Insert 54 creates a Locking Point 52, between Insert 54 and Side of Block 50 when inserted into “V” groove 47 of block 30. This creates a “Snap-Lock” system that locks Bottom Block 40 with Upper Block 30. Below Side of Block 50 is the lower Side of Block 56. On the inner wall of Side of Block 56 is previously mentioned horizontal “V” groove 47, spanning the length of the block on each side. The insert 54 on lower Block 40 snaps into the V-groove 47 on Top Block 30, tightly binding the two blocks. As multiple blocks are assembled, a complete wall is created.

An additional feature includes a Groove 45 and a Tongue 43 that extend from each end of Bottom Block 40. All blocks have Grooves 45 on one end and Tongues 43 on the opposite end to allow adjoining blocks to lock into position horizontally, end to end. Use of this interlocking system on the Top, Bottom and End of blocks, creates a strong and durable wall that may be used to build a structure.

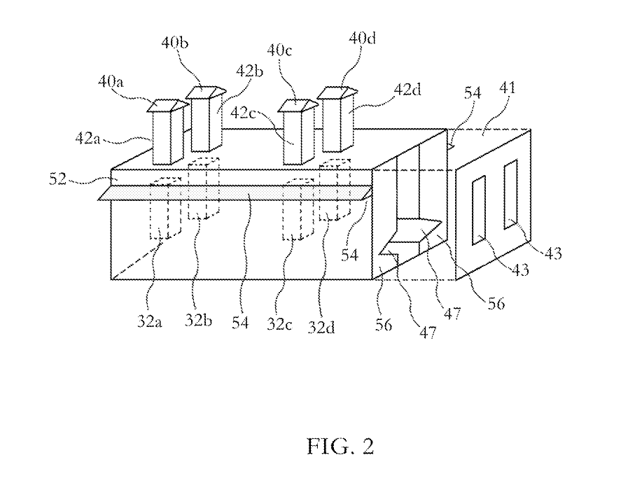

Within a prospective view provided in FIG. 2, the Inner Cavities 32a, 32b, 32c and 32d are seen within the Block 40. Further the horizontal Insert 54 is shown extending along the length of the Block 40 just above the locking point for the lower Block 56. The Studs 42a, 42b, 42c and 42d are shown extending above the top surface of Block 40 and may be engaged with an additional block on top of the Block 40. Tongue and Groove Fittings 43 are shown at one end of the Block 40 that allow for the engagement of the Block 40 with a receiving horizontal block. As a result, the block system provides a quick and effective means to construct structures in an efficient manner.

A primary advantage of this particular system, is that because the blocks are made of a semi-flexible synthetic rubber material, they are able to absorb powerful impact forces of nature created by hurricanes, earthquakes and tornadoes. Further, because the blocks are economical and easy to assemble, they can provide much needed shelter or temporary housing for victims of such disasters.

Preferably, the blocks will measure 19 inches tall by 12 inches wide by 24 inches long. This allows for light weight and ease of handling. The described interlocking connections make them difficult to separate once attached. For greater safety, it is advisable to implement a fire retardant substance into materials used to manufacture the construction blocks.

The instant invention has been shown and is described in what is considered to be the most practical and preferred embodiments. It is recognized however, that departures may occur from within the scope of the invention, and that obvious modifications will occur to a person skilled in the art.

1. A synthetic rubber construction block system comprising:
a) a top block;
b) a plurality of cavities on a under side of the top block;
c) a bottom block;
d) a plurality of studs on a upper side of the bottom block whereby the plurality of studs are inserted into the plurality of cavities, whereby the top and bottom blocks are adjoined;
e) an insert on a upper outside area of the bottom block;
f) a V-groove on a lower inside area of the upper block that receives the insert from the bottom block, binding them together;
g) a locking point between the insert and a side of block area; and
h) a lower side of block area;

2. A synthetic rubber construction block system according to claim 1, whereby each of the top and bottom blocks further include a tongue and groove connection on each end, wherein the tongue and groove connections enabling a horizontal joining of the blocks;

3. A synthetic rubber construction block system according to claim 1, whereby the preferred dimensions of each block is 19 inches tall by 12 inches wide by 24 inches long.
